(19) United States
(12) Patent Application Publication
(10) Pub. No.: US 2008/0230561 A1
(43) Pub. Date: Sep. 25, 2008

(54) Micro-applicator for use with disposable tips

(76) Inventor: Phillip Mark, Orlando, FL (US)

Correspondence Address: MCDERMOTT, WILL & EMERY LLP, 227 WEST MONROE STREET, SUITE 4400, CHICAGO, IL, 60606-5096, US

(21) Appl. No.: 11/725,907

(22) Filed: Mar. 19, 2007

(51) Int. Cl. B67D 5/42; A61C 5/04

(52) U.S. Cl. 222/343; 433/90

(57) ABSTRACT

A micro-applicator includes a body and a tip holder located at an end of the body. A spring-loaded plunger extends through the body such that when sufficient force is applied to the end of the plunger extending out of the body, the plunger extends into the tip holder to eject a tip held therein. Another micro-applicator includes a grip, a tip holder located at an end of the grip and a spring-biased ejector configured such that compression of the spring causes the ejector to extend through tip holder and eject a tip held therein. Another micro-applicator includes a body, including a grip portion and a tip holding portion. The tip holding portion is configured to hold a disposable dental tip. A spring-biased ejector located within the body allows quick and efficient ejection of the disposable dental tip.

### TECHNICAL FIELD

The disclosed embodiments relate generally to a micro-applicator for use with disposable tips. More specifically, the present subject matter relates to a micro-applicator with a compression fit tip holder and a spring-loaded ejector.

### BACKGROUND

Micro-applicators are used in the dental field for fast application of materials in areas of limited access. For example, micro-applicators can be used for applying sealants, bonding agents, etchants, hemostatic solutions, cavity liners, disclosing solutions, etc. Micro-applicators include a body portion, or handle, by which the user grips the micro-applicator and a tip portion to apply a material. The tip portion is often a bristled tip optimized for the application of a fluid or paste, though adhesive tips and other tip designs are also used. In order to avoid contamination and other hygienic concerns, micro-applicators are typically disposable. Further, various sizes of tips are used for different materials and procedures. As a result, four to six micro-applicators may be required for a typical dental procedure.

Certain micro-applicators do not have the ability to eject or otherwise dispose of the tip without also disposing the body, thereby creating an excessive amount of waste. Other micro-applicators enable the tip to be removed from the body, but it is difficult for a user to remove the tip from the body without getting the material on the tip on the user's fingers or gloves.

As with many medical devices, the ergonomic feel of a micro-applicator is important. Many dentists prefer medical devices that are comfortable to manipulate and feel like quality instruments.

Therefore, a need exists for a micro-applicator with a disposable tip that allows for quick and efficient tip changeovers while reducing unneeded waste and preventing contamination of the user's fingers or gloves.

### SUMMARY

The above and other needs are met by the disclosed embodiments which provide a micro-applicator with a tip holder and a spring-loaded ejector. The micro-applicator includes a body and a tip holder located at an end of the body. A spring-loaded plunger extends through the body such that when sufficient force is applied to the end of the plunger extending out of the body, the plunger extends into the tip holder to eject a tip held therein. Another micro-applicator includes a grip, a tip holder located at an end of the grip and a spring-biased ejector configured such that compression of the spring causes the ejector to extend through tip holder and eject a tip held therein. Yet another micro-applicator includes a body, including a grip portion and a tip holding portion. The tip holding portion is configured to hold a disposable dental tip. A spring-biased ejector located within the body allows quick and efficient ejection of the disposable dental tip.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements.

FIG. 1 is a cross-sectional side view of a micro-applicator.

FIG. 2 is an exploded perspective view of the micro-applicator shown in FIG. 1.

### DETAILED DESCRIPTION OF PREFERRED EMBODIMENTS

It is contemplated that the subject matter described herein may be embodied in many forms. Accordingly, the embodiments described in detail below are the presently preferred embodiments, and are not to be considered limitations.

The disclosed embodiments address problems related to micro-applicators. The disclosed embodiments solve these problems, at least in part, by providing a micro-applicator with a compression fit tip holder and a spring-loaded ejector. For example, a micro-applicator includes a body and a tip holder located at an end of the body. A spring-loaded plunger extends through the body such that when sufficient force is applied to the end of the plunger extending out of the body, the plunger extends into the tip holder to eject a tip held therein.

The disposable tip is often a bristle brush tip, a foam applicator tip or an adhesive tip, though other tip designs may also used. In fact, any small, disposable tip may benefit from the solutions provided herein.

The earlier stated needs and others are met by still other disclosed embodiments of a micro-applicator with a compression fit tip holder and a spring-loaded ejector. For example, another micro-applicator includes a grip, a tip holder located at an end of the grip and a spring-biased ejector configured such that compression of the spring causes the ejector to extend through tip holder and eject a tip held therein. Still another micro-applicator includes a body, including a grip portion and a tip holding portion. The tip holding portion is configured to hold a disposable dental tip. A spring-biased ejector located within the body allows quick and efficient ejection of the disposable dental tip.

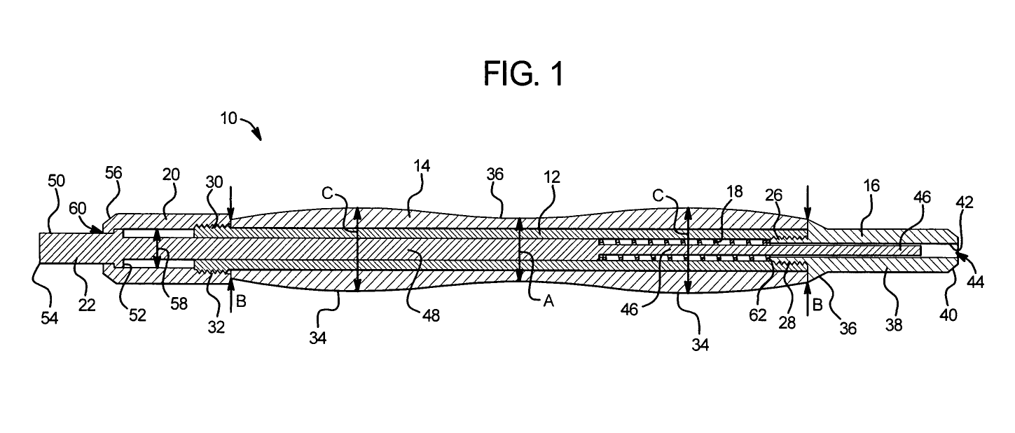

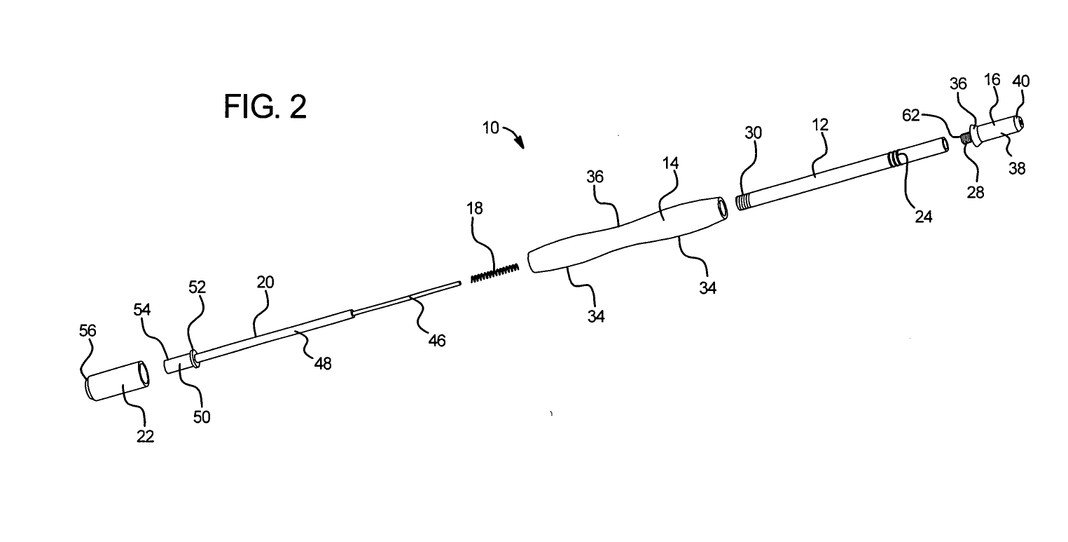

FIGS. 1 and 2 illustrate a micro-applicator 10 shown in cross-section and exploded perspective view, respectively. As shown, the micro-applicator 10 includes a body 12, a grip 14, a tip holder 16, a spring 18, a plunger 20 and an end cap 22. It is understood that the embodiment shown in FIGS. 1 and 2 is merely one contemplated embodiment that meets the needs expressed above by implementing the solutions provided herein. For example, it is contemplated that in another example the end cap 22 may be integrally formed with the body 12. Similarly, it is contemplated that the body 12 and grip 14 may be implemented in a unitary piece or, alternatively, by more than two pieces.

As shown in FIGS. 1 and 2, the body 12 forms the central portion of the micro-applicator 10. In the embodiment shown in FIGS. 1 and 2, the body 12 is generally cylindrical elongated tube formed of a polymeric material. The body 12 includes one or more ribs 24 spaced radially along the outer diameter of the body 12. The ribs 24 assist in keeping the grip 14 in place surrounding the body 12. Although the embodiment shown herein includes six ribs 24, other configurations may be appropriate based on the dimensions and materials employed, including using a body 12 without ribs 24.

In the embodiment shown, the body is approximately 4.013 inches long, with an inner diameter of approximately 0.159 inches and an outer diameter of approximately 0.250 inches. The ribs 24 extend beyond the outer diameter of the body 12 by approximately 0.005 inches and have a diameter of approximately 0.030 inches. The end of the body 12 that attaches to the tip holder 16 is internally threaded 26 to mate with the external threads 28 of the tip holder 16, as described further below. The internal threads 26 extend approximately 0.313 inches into the body 12 and are 10-32 TPI. The end of the body 12 that attaches to the end cap 22 is externally threaded 30 to mate with the internal threads 32 of the end cap 22, as described further below. The external threads 30 extend approximately 0.233 inches along the body 12 and are ¼ 28 TPI. Moreover, in the embodiment shown, the ribs 24 do not extend onto the externally threaded 30 portion of the body 12.

Although the embodiment shown is the presently preferred embodiment, it is contemplated that other dimensions, materials and methods of attachment, including integral formation of the various portions of the micro-applicator 10, may be implemented without departing from the solutions described herein. For example, the body 12 and end cap 22 may be one-piece formed from metal, such as, for example, stainless steel or aluminum.

The grip 14 shown in FIGS. 1 and 2 is an ergonomically shaped textured rubber grip 14. The grip 14 is designed to be comfortable in shape, material and texture when held by a user. In the example shown, the ergonomic profile of the grip 14 includes two peaks 34 and one valley 36. As shown, the grip 14 surrounds the body 12 such that a user holds the micro-applicator 10 by the grip 14 rather than by the body 12. As further shown, the grip 14 does not cover the externally threaded 30 portion of the body 12.

In the example shown, the grip 14 is approximately 3.75 inches long, with each peak 34 being approximately 1.29 inches long and the valley being approximately 1.17 inches long. The peaks 34 have a radius of approximately 4.356 inches and the valley has a radius of approximately 4.724 inches. The grip 14 includes an inner diameter of approximately 0.250 inches, a minimum outer diameter A located near the middle of the grip 14 of approximately 0.390 inches, a second outer diameter B located at either end of the grip 14 of approximately 0.400 inches and a maximum outer diameter C located at the each peak 34.

It is understood that other grip profiles, dimensions, materials and textures may be employed without departing from the solutions described herein. For example, the grip 14 may be a generally cylindrical profile formed from untextured stainless steel or aluminum. Also, other dimensions may be preferred for other embodiments of the micro-applicator 10 described herein. Further, it is contemplated that in another example, the grip 14 may be integrally formed with the body 12.

The tip holder 16 shown in FIGS. 1 and 2 includes an externally threaded portion 28, as described above, a transition portion 36, a cylindrical portion 38, a tapered tip 40 and an internal surface 42 forming an internal passage 44. The internal surface 42 is configured to accept disposable dental tips and grasp them by a compression fit. The internal surface 42 may be tapered such that the diameter of the internal passage 44 varies along the length of the tip holder 16, which enables a dental tip to be grasped simply by pushing the dental tip further into the internal passage 44 until the internal surface 42 grasps the dental tip with compressive force. Similarly, the internal surface 42 may be concavely shaped to grasp the dental tip in a similar manner. Further, the internal surface 42 may be smoothly finished, as shown in FIGS. 1 and 2, or may include bumps, ridges, ribs, or other irregularities to aid in grasping the dental tip.

In the example shown in FIGS. 1 and 2, the tip holder 16 is approximately 1.218 inches long. The externally threaded portion 28 is approximately 0.250 inches long with 10-32 TPI threads. The transition portion 36 is approximately 0.150 inches long and transitions at an angle of approximately 25 degrees from a maximum diameter of approximately 0.406 inches to an external diameter of approximately 0.266 inches where it meets the cylindrical portion 38. The cylindrical portion 38 is approximately 0.666 inches long and transitions to the tapered tip 40, which is approximately 0.152 inches long and at an angle of approximately 9 degrees. The end of the tapered tip 40 is rounded over with a radius of approximately 0.013 inches. The internal surface 42 and corresponding internal passage 44 may be configured to appropriately interface the dental tips to be grasped, but in the embodiment shown, the maximum internal diameter of the internal surface 24 is approximately 0.125 inches.

It is understood that other dimensions and materials may be employed without departing from the solutions described herein. For example, the tip holder 16 may be formed from stainless steel, aluminum or a polymeric material. However, in the embodiment shown, the tip holder 16 is formed from stainless steel. Further, in another example, the tip holder 16 may be integrally formed with the body 12.

As shown in FIGS. 1 and 2, the plunger 20 is an elongated, stepped, cylindrical shaft that extends through the body 12 of the micro-applicator 10. In the example shown, the plunger 20 generally includes three main cylindrical portions, a tip clearing portion 46, a main portion 48 and a push button portion 50. The tip clearing portion 46 is adapted to travel through the internal passage 44 of the tip holder 16 in order to eject a dental tip held within the internal passage 44. Accordingly, in the example shown, the tip clearing portion 46 is approximately 1.995 inches long and approximately 0.110 inches in diameter. These dimensions enable the tip clearing portion 46 to travel through the entire length of the tip holder 16 to ensure proper ejection of the dental tip.

The main portion 48 is approximately 3.000 inches long and approximately 0.150 inches in diameter. Accordingly, the main portion 48 is able to translate within the body 12 without extending into the tip portion 16.

As shown, the push button portion 50 includes a flared end 52 and a tapered end 54. The flared end enables the plunger 20 to be held within the body 12 by the end cap 22, as described further below. As shown in FIGS. 1 and 2, the flared end 52 is approximately 0.050 inches long and approximately 0.210 inches in diameter. The push button portion 50 is approximately 0.580 inches long (including the flared end 52) and approximately 0.180 inches in diameter. The tapered end 54 has an approximately 0.030 inch radius. These dimensions allow the push button 50 to translate within the end cap 22, but not to be pushed completely through the end cap 22, as described further below.

The plunger 20 shown in FIGS. 1 and 2 is formed of a polymeric material. However, it is understood that other profiles, dimensions and materials may be employed without departing from the solutions described herein. For example, the plunger may be stainless steel or aluminum. Also, other dimensions may be preferred for other embodiments of the micro-applicator 10 described herein.

The end cap 22 shown in FIGS. 1 and 2 includes an internally threaded portion 32 that mates with the external threads 30 of the body 12. Accordingly, the internally threaded portion 32 is approximately 0.312 inches long and has ¼ 28 TPI threads. The overall length of the end cap 22 is approximately 0.800 inches long and an outer diameter of approximately 0.406 inches. The end cap 22 further has a tapered end 56 that has a 0.050 inch radius. Internally the end cap 22 includes a main internal diameter 58 that is approximately 0.213 inches and an end hole 60 with a diameter of approximately 0.193 inches. Thus, when assembled as shown in FIG. 1, the flared end 52 of the plunger 20 is prevented from passing through the end hole 60. Thus, the plunger 20 is held in place within the body 12 by the end cap 22.

It is understood that other dimensions and materials may be employed without departing from the solutions described herein. For example, the end cap 22 may be formed from stainless steel, aluminum or a polymeric material. However, in the embodiment shown, the end cap 22 is formed from stainless steel. Further, in another example, the end cap 22 may be integrally formed with the body 12.

As further shown in FIGS. 1 and 2, the spring 18 seats within the body 12 to bias the plunger 20 away from the tip holder 16. The spring 18 shown in the example provided is made from 0.016 inch diameter stainless steel and is approximately 1.375 inches in length and 0.156 inches in diameter. As shown in FIG. 1, the spring 18 seats against the spring biasing portion 62 of the tip holder 16 on one end and against the main portion 48 of the plunger 20 at the other end of the spring 18. When a force is applied to the push button portion 50 of the plunger 20 sufficient to compress the spring 18, the plunger 20 extends into the tip holder 16 to eject a dental tip held therein. When no force is applied to the push button portion 50 of the plunger 20, the spring 18 remains uncompressed, as shown in FIG. 1.

In the example shown, when the spring 18 is fully compressed, the tip clearing portion 46 of the plunger 20 extends through and out of the tip holder 16. However, it is contemplated that in other examples the tip clearing portion 46 may not necessarily have to extend out of the tip holder 16 in order to solve the problems addressed herein. It is further contemplated that the compression coil spring 18 shown in FIGS. 1 and 2 is just one example of a spring 18 that may be used in the micro-applicator 10 described herein. For example, other embodiments may utilize tension springs, leaf springs, cantilever springs, etc. Moreover, the spring biasing portion 64 may be embodied in a portion of the tip holder 16, the grip 14, the body 12 or in any other portion of the micro-applicator.

The micro-applicator 10 described herein and shown in FIGS. 1 and 2 is an ergonomic instrument that many dentists will find to be a quality instrument. Accordingly, the deficiencies of the prior art are overcome by the micro-applicator 10 disclosed herein.

It should be noted that various changes and modifications to the presently preferred embodiments described herein will be apparent to those skilled in the art. Such changes and modifications may be made without departing from the spirit and scope of the present invention and without diminishing its attendant advantages.

1. A micro-applicator comprising:
a body;
a tip holder located at a first end of said body;
a spring-biased plunger located, at least in part, within said body, wherein said plunger is biased to extend out of a second end of said body, further wherein application of a sufficient force to the portion of said plunger extending out of said second end of said body causes said plunger to extend through said tip holder, thereby ejecting any element held therein.

2. The micro-applicator of claim 1 wherein said tip holder is integrally formed with said body.

3. The micro-applicator of claim 1 wherein said tip holder is connected to said body by a threaded attachment.

4. The micro-applicator of claim 1 where in said tip holder includes a tapered inner diameter.

5. The micro-applicator of claim 1 where in said tip holder includes a concave inner diameter.

6. The micro-applicator of claim 1 further comprising a grip portion attached to said body.

7. The micro-application of claim 1 wherein said body is a rubberized body having an ergonomic outer profile.

8. A micro-applicator comprising:
a grip;
a tip holder located at a first end of said grip; and
a spring-biased ejector configured such that compression of said spring causes said ejector to extend through said tip holder, thereby ejecting any element held therein.

9. The micro-applicator of claim 8 wherein when said spring is uncompressed, said ejector extends through a second end of said grip.

10. The micro-applicator of claim 8 wherein said tip holder is attached to said grip by a threaded attachment.

11. The micro-applicator of claim 8 wherein said tip holder includes a spring-biasing portion against which said spring is compressed when sufficient force is applied to said ejector.

12. The micro-applicator of claim 8 wherein said grip includes a spring-biasing portion against which said spring is compressed when sufficient force is applied to said ejector.

13. A micro-applicator comprising:
a body including a grip portion and a tip holding portion, wherein said tip holding portion is configured to accept and hold a disposable dental tip; and
a spring-biased ejector located, at least in part, within said body, wherein said spring-loaded ejector is biased by a spring located within said body such that an application of force sufficient to overcome the spring's biasing force causes said ejector to extend into said tip holding portion, thereby ejecting any element held therein.

14. (canceled)

15. (canceled)

16. The micro-applicator of claim 13 wherein said grip portion is a textured rubber grip portion.

17. The micro-applicator of claim 13 wherein said grip portion has an ergonomic profile.

18. The micro-applicator of claim 13 further comprising a body, wherein said tip holding portion is attached to said body by a threaded connection and said grip portion surrounds at least a portion of said body.

19. The micro-applicator of claim 13 wherein said tip portion includes a tapered inner diameter.

20. The micro-applicator of claim 13 wherein said tip portion includes a concave tapered inner diameter.
